(19) United States
(12) Patent Application Publication
(10) Pub. No.: US 2005/0129890 A1
(43) Pub. Date: Jun. 16, 2005

(54) Automotive driveline components manufactured of hydrogenated nitrile butadiene rubber material

(76) Inventor: Shen-Ling Allen Wang, Northville, MI (US)

Correspondence Address: Jennifer M. Brumbaugh, 3300 University Drive, Auburn Hills, MI, 48326-2362, US

(21) Appl. No.: 10/912,400

(22) Filed: Aug. 5, 2004

(51) Int. Cl. B32B 1/08

(52) U.S. Cl. 428/36.9

(57) ABSTRACT

A sealing component constructed of hydrogenated nitrile butadiene rubber (“HNBR”) compound for use in high temperature, high speed and high angle applications is disclosed. The disclosed HNBR material may also be reinforced with fibers for added stiffness and stability.

### BACKGROUND OF THE INVENTION

The present inventions relates to driveline sealing components constructed of rubber material and more particularly to a boot assembly for a constant velocity joint that is capable of withstanding high temperature, high speed, and high angle applications that is constructed of hydrogenated nitrile butadiene rubber.

Driveline sealing components are frequently used for covering the chamber of a joint that is filled with a lubricating agent. The sealing components prevent lubricating agents from leaving the joint chamber while preventing dirt and other contaminants from entering the joint chamber.

One application that utilizes sealing components is constant velocity joints. A constant velocity joint is used to transmit the rotating power from one joint member to the other joint member so as to rotate at a constant velocity while allowing the above two joint members to freely deflect the axial center lines thereof from each other within a predetermined angle range. When the constant velocity joint is used in a driveline system of a vehicle, the joint portion of the constant velocity joint is typically covered with a boot. The boot is flexible and generally has a deformable shape such as bellows. A typical boot includes a first relatively large end that is secured to an outer race of the constant velocity joint and a second relatively small end that is secured to a shaft extending from an inner race of the constant velocity joint. In other words, one open end of the dust boot is positioned on the outer periphery of one joint member while the other open end is positioned on the outer periphery of the other joint member.

In the boot of this type, adjacent folds locally come in contact with one another when the constant velocity joint rotates at a high velocity with a large joint angle. As a result, wear occurs in the boot, reducing the sealing effectiveness of the boot, and shortening the effective life of the boot. One known solution to overcome the wear problems of the boot, is to include wax in the boot to smooth the outer surface of the dust boot. However, undesirable wear still occurs, especially in high temperature applications. Accordingly, there is a need for a boot that is capable of withstanding high temperature, high speed, and high angle applications.

### SUMMARY OF THE INVENTION

The present invention relates to sealing components for an automotive driveline assembly having a unitary body for use in high temperature, high velocity and high angle applications. In accordance with an aspect of the present invention, the sealing assembly is a boot seal for a constant velocity joint as specified in claim 1. To address the undesirable wear conditions of known boots, the boot of the present invention is preferably constructed of hydrogenated nitrile butadiene rubber (“HNBR”). Boots constructed of HNBR have been found to be capable of withstanding 150° C. peak temperatures and 130° C. constant operating temperatures. Further, adding reinforcing fibers to the HNBR material may increase stiffness in the boot.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a perspective view of an embodiment of a flexible boot assembly for a constant velocity joint in accordance with the invention;

FIG. 2 is plan view of the flexible boot assembly of FIG. 1.

FIG. 3 is a cross-sectional view of the flexible boot assembly of FIG. 1, taken along lines 3-3 of FIG. 2.

FIG. 4 is an enlarged view of one end of the flexible boot assembly taken from FIG. 3.

FIG. 5 is an enlarged view of another end of the flexible boot assembly taken from FIG. 3.

FIG. 6 is an enlarged view of an optional design of the second end of the flexible boot assembly.

### DETAILED DESCRIPTION

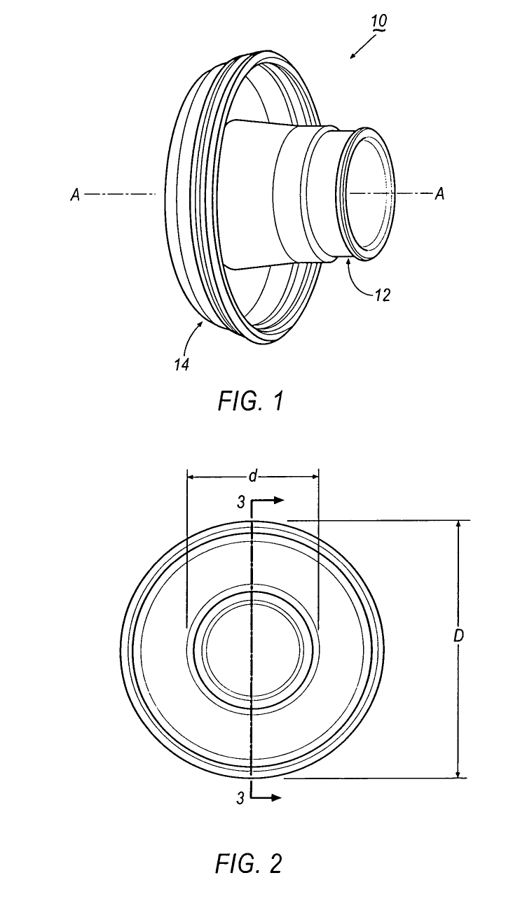

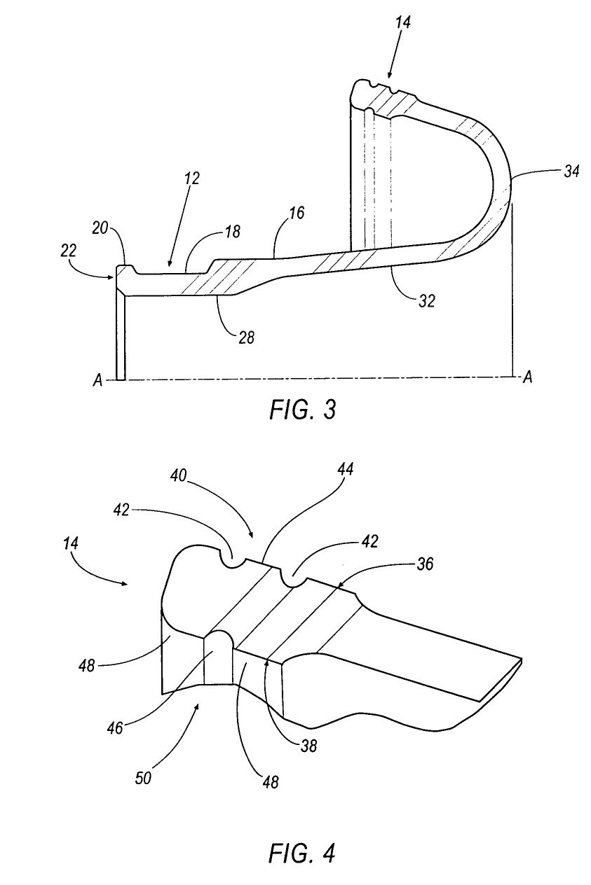

Referring to FIGS. 1-6, an embodiment of a flexible boot assembly, indicated generally at 10, for use with a constant velocity joint, is shown. Boot assembly 10 includes a first sealing end portion 12, and a second sealing end portion 14. First sealing end portion 12 has a first outer diameter d that is less than an outer diameter D of second sealing end portion 14. Both first and second sealing end portions 12, 14 are positioned around a common axis A.

An outside surface 16 of first end portion 12 includes an annular groove 18 formed therearound. An annular ridge 20 extends around a distal end 22 of first sealing end portion 12, adjacent to annular groove 18. Annular ridge 20 defines an inwardly sloping first flange 24. A second flange 26 is positioned opposite first flange 24. Second flange 26 also slopes inwardly toward annular groove 18 from the outside surface 16.

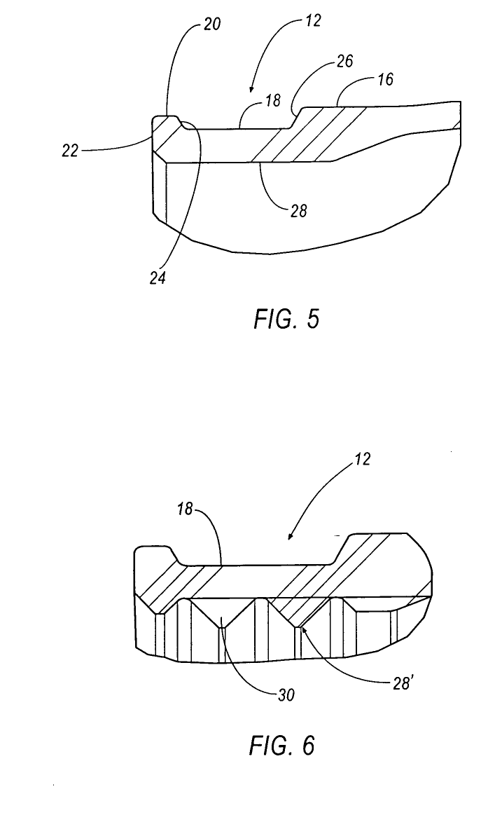

First end portion 12 also includes an inner contact surface 28. Inner contact surface 28 may be generally planar as shown in FIG. 5. Alternatively, inner contact surface 28′ may include a plurality of ridges 30 as shown in FIG. 6. In operation, inner contact surface 28 or 28′ of first end portion 12 frictionally engages the outside surface of a shaft (not shown). A metal band clamp (not shown) or other retaining structure may be provided to secure first end portion 12 to the shaft. The inwardly extending flanges 24 and 26 serve to direct the clamp to the center of annular groove 18.

Second end portion 14 is connected to first end portion 12 by a main body portion 32 and a wall portion 34. In one embodiment, wall portion 34 is curved. In another embodiment (not shown) wall portion 34 may be substantially planar. Second end portion 14 includes an outer surface 36 and an inner surface 38. As best shown in FIG. 4, outer surface 36 may include a plurality of ribs 40 defined by a series of grooves 42 separated by lands 44. Alternatively, outer surface 36 may include an annular groove (not shown) similar to annular groove 18 provided on first end portion 12. Inner surface 38 may also be provided by at least one groove 46 that is flanked by lands 48. Groove 46 and lands 48 provide an engagement surface 50 for engaging an outer race (not shown) of the constant velocity joint.

In accordance with another aspect of the invention, boot 10 is preferably a unitary construction that is made of a hydrogenated nitrile butadiene rubber compound (“HNBR”) that is particularly suited for high temperature applications, such as applications that have a 150° C. peak temperature and/or a 130° C. continuous temperature. The inventive compound includes the following components: a hydrogenated nitrile elastomer such as Zetpol® available from Zeon Chemical Products, Inc.; magnesium oxide such as Maglite D from C.P. Hall Company; a plasticizer that improves oil and heat resistance such as TP-95 distributed by Rohm and Haas; a release agent, such as stearic acid; at least one antioxidant that acts as a thermal stabilizer such as Naugard® 445 distributed by Uniroyal Chemical Company, Inc. or Rhenogan ZMMBI-50 distributed by Rhein-Chemie Rheinau GmbH; a peroxide such as Vulcup 40KE distributed by Hercules Inc.; and filler material such as carbon black. In a preferred embodiment, the HNBR material includes two different antioxidants.

In some applications, high stiffness and increased strength is needed. To address such needs, in accordance with another aspect of the invention, the above-described HNBR material may be reinforced with fibers. More specifically, the HNBR material includes a fiber content from about 3-10 part per hundred rubber by weight pphr and preferably 5 pphr. A suitable fiber includes a phenolic based fiber such as Kynol® KF02BT that is distributed by American Kynol, Inc. The preferred fibers are approximately 15 μm in diameter, have an average length of 0.2 mm and have approximately 30-50% elongation.

The fibers may be added to the HNBR material in a number of different methods. To insure that the fibers are sufficiently dispersed in the resulting boot, one method includes injection molding a first layer of the HNBR material into the shape of boot 10. The first layer is then cured. Next, the fibers are placed over the first layer. Alternatively, an adhesive is applied to the fibers before being placed over the first layer. A second, or top, layer is then compression molded to final form boot 10. The second layer is then cured.

In an alternative embodiment, the mold may be provided with locator pins for fixing the fibers in place as the material flows through the mold. The material is then injection molded into the boot shape and cured.

It is to be understood that the above description is intended to be illustrative and not limiting. Many embodiments will be apparent to those skilled in the art upon reading the above description. The scope of the invention should be determined, however, not with reference to the above description, but with reference to the appended claims with full scope of equivalents to which such claims are entitled.

1. A sealing component for an automotive driveline component, said sealing component having a unitary body, wherein said unitary body is constructed of hydrogenated nitrile butadiene rubber.

2. The sealing component of claim 1, wherein said hydrogenated nitrile butadiene rubber is comprised of a hydrogenated nitrile elastomer; a plasticizer; a release agent; at least one antioxidant;
peroxide; and filler material.

3. The sealing component of claim 1, wherein said hydrogenated nitrile butadiene rubber is reinforced by fibers.

4. The sealing component of claim 3, wherein said fibers are phenolic based.

5. The sealing component of claim 3, wherein said fibers have an average diameter of 15 μm.

6. The sealing component of claim 3, wherein said fibers have an average length of 0.2 mm.

7. The sealing component of claim 3, wherein said fibers have approximately 30-50% elongation.

8. The sealing component of claim 3, wherein said hydrogenated nitrile butadiene rubber mixture has a fiber content of approximately three to ten pphr.

9. The sealing component of claim 8, wherein said hydrogenated nitrile butadiene rubber mixture has a fiber content of approximately 5 pphr.

10. The sealing component of claim 1, wherein said sealing component is a boot seal for a constant velocity joint.

11. A boot seal for a constant velocity joint having a unitary body constructed of hydrogenated nitrile butadiene rubber, wherein said hydrogenated nitrite butadiene rubber is comprised of a hydrogenated nitrile elastomer; a plasticizer; a release agent; two antioxidants; peroxide; and filler material.

12. The boot seal of claim 11, wherein said hydrogenated nitrile butadiene rubber is reinforced by phenolic based fibers.

13. The boot seal of claim 12, wherein said fibers have an average diameter of 15 μm.

14. The boot seal of claim 13, wherein said fibers have an average length of 0.2 mm.

15. The boot seal of claim 14, wherein said fibers have approximately 30-50% elongation.

16. The boot seal of claim 12, wherein said hydrogenated nitrile butadiene rubber mixture has a fiber content of approximately five pphr.

17. A method of making a sealing component for automotive driveline components for high temperature applications comprising:
providing a mold assembly in a predetermined shape;
injection molding a first layer of hydrogenated nitrile butadiene rubber into said mold;
curing said first layer of hydrogenated nitrile butadiene rubber;
applying a plurality of reinforcing fibers over said first layer of cured hydrogenated nitrile butadiene rubber;
applying a second layer of hydrogenated nitrile butadiene rubber over said reinforcing fibers;
compression molding said second layer of hydrogenated nitrile butadiene rubber; and
curing said second layer of hydrogenated nitrile butadiene rubber.

18. The method of claim 17, further including the step of applying an adhesive on said reinforcing fibers before said step of applying said plurality of reinforcing fibers on said first layer of cured hydrogenated nitrile butadiene rubber.

19. The method of claim 18, wherein said reinforcing fibers are phenolic based.

20. The method of claim 19, wherein said reinforcing fibers comprise approximately 5 pphr of the hydrogenated nitrile butadiene rubber.
